(19) United States
(12) Patent Application Publication
(10) Pub. No.: US 2026/0268585 A1
(43) Pub. Date: Sep. 10, 2026

(54) EXPOSURE FIELDS FOR VIEW SYNTHESIS

(71) Applicant: GOOGLE LLC, Mountain View, CA (US)

(72) Inventors: Michael Niemeyer, Zurich (CH); Fabian Manhardt, Munich (DE); Marie-Julie Rakotosaona, Zurich (CH); Michael Oechsle, Richterswil (CH); Christina Nektaria Tsalicoglou, Zurich (CH); Keisuke Tateno, Zurich (CH); Federico Tombari, Zug (CH); Jonathan Tilton Barron, Atherton, CA (US)

(21) Appl. No.: 19/561,195

(22) Filed: Mar. 9, 2026

Related U.S. Application Data
(60) Provisional application No. 63/768,692, filed on Mar. 7, 2025.

(51) Int. Cl. G06T 15/20; G06T 15/06; G06T 15/50

(52) U.S. Cl. CPC G06T 15/20; G06T 15/06; G06T 15/506

(57) ABSTRACT

Techniques are directed to neural exposure fields, an improved technique for reconstructing scenes with 3D consistent and high-quality appearance that shows optimally-exposed colors while being consistent in 3D. The core of the technique involves learning a neural field that predicts an optimal exposure value per 3D point jointly with the scene representation. Aggregating information in 3D instead of 2D improves quality and provides 3D consistency by design as a separate per-image 2D tone-mapping process is not used. The technique also involves learning neural exposure fields jointly with grid-based radiance fields, with a novel latent exposure conditioning mechanism leading to improved performance.

### CROSS REFERENCE TO RELATED APPLICATIONS

This application claims the benefit of U.S. Provisional Application No. 63/768,692, filed on Mar. 7, 2025, the disclosure of which is hereby incorporated by reference in its entirety.

### BACKGROUND

View synthesis is a three-dimensional (3D) vision task that involves generating new images of a scene from arbitrary or novel perspectives based on an initial set of input views, such as two-dimensional image slices. At least some view synthesis programs can reconstruct a scene from these inputs in a 3D-consistent manner to produce an appearance that is faithful to the real world.

### SUMMARY

The described technology provides a way to turn standard two-dimensional (2D) photographs into highly realistic, fully explorable three-dimensional (3D) environments. Normally, when standard computer programs try to stitch regular photos together into a 3D model, they get confused by changing lighting. For example, if a camera points toward a bright window, the photo might look washed out, but if it points into a dark corner, the photo might look pitch black. When software tries to combine these differently lit photos, the resulting 3D scene often looks glitchy, unnatural, or full of dark and bright spots. To solve this problem, this technology acts as a smart, automated lighting director. Instead of trying to fix the lighting on the flat 2D photos, the system uses an artificial intelligence model to build a 3D map that understands the perfect lighting (or “exposure”) for every single spot in the physical space. If the system notices that a specific pixel in an original photo is completely ruined by bad lighting—like pure white or pitch black—it simply throws it out and focuses only on the high-quality color data. The result is a vibrant, perfectly lit, and realistic 3D world that looks like it was captured by a professional using expensive camera gear, all created from standard photos.

Specifically, the concepts discussed herein are directed to a method and system for robustly reconstructing three-dimensional (3D) scenes with high-quality and 3D-consistent appearances from real-world captures, particularly those that exhibit strong exposure and appearance changes. Specifically, these concepts are directed to a neural exposure field, a neural representation that learns to predict an optimal exposure value for each individual 3D point in a scene, rather than relying on separate 2D per-image tone-mapping processes. This neural exposure field is jointly optimized alongside a 3D scene representation model, such as a neural radiance field, utilizing a novel latent exposure conditioning mechanism. By aggregating exposure information in 3D, the system enables accurate view synthesis in high-dynamic range (HDR) scenarios, generating well-exposed, HDR-resembling novel views while bypassing the need for manual post-processing steps, reference target appearances produced by professionals, or multi-exposure captures.

In a general aspect, a method can include receiving, using a first model, a brightness at a three-dimensional location of a scene. The method can also include receiving a first perspective of the scene. The method can further include generating, using a second model, a second perspective of the scene based on the first perspective of the scene and the brightness at the three-dimensional location of the scene.

In another general aspect, a computer program product can include a nontransitory storage medium and code that, when executed by processing circuitry, causes the processing circuitry to perform a method. The method can include receiving, using a first model, a brightness at a three-dimensional location of a scene. The method can also include receiving a first perspective of the scene. The method can further include generating, using a second model, a second perspective of the scene based on the first perspective of the scene and the brightness at the three-dimensional location of the scene.

In another general aspect, an electronic apparatus can include a processor coupled to a memory. The processor can be configured to receive, using a first model, a brightness at a three-dimensional location of a scene. The processor can also be configured to receive a first perspective of the scene. The processor can further be configured to generate, using a second model, a second perspective of the scene based on the first perspective of the scene and the brightness at the three-dimensional location of the scene.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating an example scenario in novel view synthesis using a neural exposure field, according to the implementations described herein.

FIG. 2 is a diagram illustrating an example diagram illustrating an interaction between a neural exposure field and a neural radiance field in developing their respective models.

FIG. 3 is a diagram illustrating an example flow of information through a bottleneck latent vector.

FIG. 4 is a diagram illustrating an example electronic environment in which novel view synthesis using a neural exposure field is used.

FIG. 5 is a flow chart illustrating an example method of performing novel view synthesis using a neural exposure field, according to the implementations described herein.

### DETAILED DESCRIPTION

The technology described herein enables creating a realistic 3D model of a real-world place, like a room or an outdoor landscape, using several regular photographs. A common problem is that the lighting in these photos often changes; some pictures might be taken facing the bright sun and look too bright (overexposed), while others might be in the shadows and look completely dark (underexposed). When standard computer programs, such as neural radiance fields (NeRFs), try to stitch these different photos together to generate a new 3D view, these drastic changes in lighting confuse the system. The result is often a low-quality 3D scene where colors look unnatural, parts of the image appear completely washed out or pitch black, or the scene has weird visual glitches.

To solve this problem, a new technology called a neural exposure field is introduced. Instead of trying to fix the lighting on the flat, 2D photos one by one using photo editing software, a system based on the technology uses an artificial intelligence model to build a 3D map of the optimal lighting itself. A model learns and predicts the absolute perfect exposure (or brightness setting) for 3D points in the scene. This means the computer learns how lighting should ideally behave within that specific 3D space, ensuring that no matter what angle you look from, the lighting remains consistent.

This neural exposure field operates as a second model that runs parallel to the main 3D scene builder. As the system trains on the original photographs, the exposure field acts as a guide, feeding exposure information to the main scene builder to help it adjust for the tricky lighting. The system is even smart enough to use a special mathematical filter (a “weighting function”); if it spots a pixel in an original photo that is completely ruined by bad lighting-like pure white or pitch black—it simply discards it and focuses its learning on the good, well-saturated colors. This allows the system to generate highly realistic, beautiful 3D views where everything is beautifully lit, looking as though it was captured by a professional using specialized High Dynamic Range (HDR) cameras, but without actually requiring expensive equipment or manual photo editing.

Some conventional view synthesis applications have considered exposure information in this context from a computer graphics perspective. In such a perspective, the aim has been to either reproduce images with certain exposures or recover a high dynamic range (HDR) representations that can be tone-mapped via professional software. Nevertheless, the goal of many applications is not only to reproduce input views at the same exposure, but to reconstruct scenes from RGB images in a 3D consistent manner and with an appearance that is faithful to the real world. Other conventional view synthesis applications do not consider input exposure and aim to recover a 3D consistent scene by explaining away per-image variations.

A technical problem with the above-described conventional view synthesis applications is that, while being a robust solution for smaller appearance changes, such applications may lead to non-ideal color predictions when drastic variations are present. Additionally, parts of the scene can be over- or under-exposed. While another approach involves learning more local bilateral mappings to explain per-image appearance changes, a separate processing step may be required together with a target appearance, e.g., given by an HDR image produced by an artist of professional software.

A technical solution to the technical problem may involve neural exposure fields, an improved technique for reconstructing scenes with 3D consistent and high-quality appearance that shows optimally-exposed colors while being consistent in 3D. The core of the technique involves learning a neural field that predicts an optimal exposure value per 3D point jointly with the scene representation. Aggregating information in 3D instead of 2D improves quality and provides 3D consistency by design as a separate per-image 2D tone-mapping process is not used. The technique also involves learning neural exposure fields jointly with grid-based radiance fields, with a novel latent exposure conditioning mechanism leading to improved performance.

The technical solution described above may include a neural representation for predicting improved exposure values per 3D point. The improved technique also may include a system to jointly learn the exposure field and the neural 3D scene representation with a novel latent conditioning mechanism that produces high-quality view synthesis while being consistent in 3D.

A technical advantage of the technical solution is that the technical solution provides about a 45% improvement in consistency over a baseline approach, and the technical solution qualitatively avoids the severe scene degradation, floating artifacts, and washed-out or pitch-black areas common in prior models, thereby successfully recovering well-exposed details across both bright and dark areas of a single scene. Unlike conventional methods that rely on 2D per-image tone-mapping, which can cause inconsistent synthesis across different views, aggregating exposure information in 3D inherently guarantees 3D-consistent, high-quality appearances by design. Furthermore, the system successfully generates High Dynamic Range (HDR)-resembling novel views without requiring manual post-processing steps, expensive multi-exposure HDR camera captures, or reference target appearances curated by professional artists.

Using the disclosed techniques, the above-described technology can be used in large-scale 3D mapping and navigation products. When capturing images of real-world environments for these products, the cameras often experience differing exposure times and settings as they move through various lighting conditions. If a standard neural radiance field (NeRF) is run naively on these images, the resulting 3D model quality is quite low due to these varying exposures. By utilizing a Neural Exposure Field alongside the NeRF model to predict optimal exposures for any 3D point, the system can condition the rendering process to generate much higher-quality, 3D-consistent novel views of the mapped environments.

Another example applies to architectural visualization or real estate, particularly for challenging high-dynamic range environments like indoor rooms with large window fronts overlooking outdoor areas. In conventional view synthesis, trying to reconstruct such scenes often results in either the indoor area losing detail (e.g., carpet structures) or the outdoor area becoming completely over-exposed, causing details like cars outside to be barely visible. The disclosed techniques overcome this by predicting optimal exposure in 3D, allowing it to produce well-exposed colors for the entire scene. This means a high-quality, High Dynamic Range (HDR)-resembling model of a real estate property can be generated without requiring manual post-processing, costly professional software, or a reference target appearance produced by an artist.

Another example applies to casual “in-the-wild” 3D photography using everyday devices like smartphones. When a user captures a burst of photos or a video around an object or scene with a phone, the device's auto-exposure often causes strong exposure changes between frames. The technology seamlessly handles these strong exposure changes by learning a 3D consistent exposure field directly from the input captures. This allows ordinary users to generate visually appealing, high-quality 3D view synthesis from their casual phone captures, completely bypassing the need for expensive multi-exposure HDR camera equipment.

As used herein, a “model” refers to a computational or mathematical representation, such as a machine learning model, an artificial neural network, or a multi-layer perceptron (MLP), that is configured to learn and predict outputs based on input data. In the context of the described view synthesis system, a model may represent a neural radiance field (NeRF), which acts as a scene representation that maps a point in 3D space and a viewing direction to a volume density and an RGB color value. A model may also represent a neural exposure field (NeEF), parameterized as a fully-connected MLP, which is configured to predict an optimal exposure value for an individual 3D point within a scene. Additionally, a model may be configured to parameterize the scene utilizing structures such as 3D Gaussian splats. In various implementations, the system utilizes a multi-model architecture-such as a first model (e.g., a neural exposure field) and a second model (e.g., a neural radiance field)—that are jointly optimized using specific cost and weighting functions to generate high-quality, 3D-consistent novel perspectives of a scene.

As used herein, the term “brightness” generally refers to the lighting parameters, capture device settings, or lighting level of an image, scene, or specific three-dimensional location or point. In the context of the described view synthesis systems, brightness is closely related to and frequently utilized interchangeably with the concept of “exposure.” Rather than attempting to manually adjust the brightness on flat, two-dimensional photos using photo editing software, the described system utilizes a computational model, such as a neural exposure field, to build a 3D map of the optimal lighting itself. This model learns and predicts the absolute perfect exposure or brightness setting for individual 3D points within the environment. By determining these brightness parameters directly in a three-dimensional space, the system ensures that the lighting remains consistent from any viewing angle, enabling the generation of high-quality novel views even from input captures that originally exhibited significant fluctuations in brightness, overexposed areas, or deep shadows. In some contexts, “brightness can refer to any of the following: A value representing the optimal lighting parameter or exposure setting generated by a computational model for a specific three-dimensional location within a scene; a lighting characteristic evaluated at a point along a ray passing through a three-dimensional space, which is combined with a function of transmittance to compute a predicted visual appearance; or a locally predicted lighting condition for an individual spatial coordinate that ensures a synthesized color prediction at that point remains well-exposed across varying viewing perspectives.

As used herein, “exposure” refers to a value representing the lighting or brightness parameters of an image or scene, which can originate from capture device settings such as varying exposure times. In the context of the described neural representations, exposure may be defined not merely as a function of camera location and viewing direction, but rather as a function of a three-dimensional (3D) position. For instance, a neural exposure field may predict an optimal or predicted exposure value for an individual 3D point, functioning as a mapping from 3D space to a 1D exposure value. Furthermore, an exposure may be computed along at least one ray passing through a 3D point, with the exposure being equal to the product of a function of transmittance and a local exposure at a point along that ray. This predicted exposure information may also be transformed, such as into a logarithmic space, to condition a neural radiance field, thereby allowing the system to accurately render 3D-consistent appearances across a scene.

As used herein, a “scene” refers to a three-dimensional (3D) space, environment, or physical subject that is undergoing reconstruction or view synthesis. A scene may comprise a variety of real-world environments, such as room-level indoor spaces, outdoor landscapes, or casual “in-the-wild” captures that exhibit complex or varying lighting conditions. To generate a model of a scene, the system typically acquires a set of input captures, such as two-dimensional (2D) RGB images representing different perspectives or view slices of the physical space. Within the context of the described neural representations, a scene comprises a plurality of 3D points in space, for which models like a neural radiance field and a neural exposure field are configured to evaluate and predict attributes such as volume density, color values, and optimal exposure values. Additionally, a scene can be parameterized by these models utilizing neural network architectures like multi-layer perceptrons (MLPs) or represented using 3D Gaussian splats to ultimately generate 3D-consistent novel views.

As used herein, “three-dimensional location” refers to specific spatial coordinate or location within a three-dimensional space or scene (e.g., x ∈ [symbol] ³) that is evaluated by a computational model. In the context of neural scene representations, a three-dimensional point may be a sample point located along a ray, for which a neural radiance field maps the point and a viewing direction to a volume density and a color value (e.g., an RGB color value). Furthermore, a three-dimensional point represents a location for which a neural exposure field predicts an optimal exposure value, functioning as a mapping from 3D space to a 1D exposure value to ensure the point is well-exposed. The described system may evaluate specific characteristics at a given three-dimensional point, such as computing a predicted exposure along a ray passing through the point, evaluating differences between predicted and observed colors or exposures at the point, or regularizing the exposure field by comparing the predicted exposure at the three-dimensional point to the exposure at another nearby three-dimensional point offset by a normally-distributed noise vector.

As used herein, a “perspective” refers to a two-dimensional image slice or view of a three-dimensional (3D) scene. For example, a “first perspective” can be an acquired input view of the 3D scene, which may have an assigned exposure level determined based on a model. While the elements that are evaluated, optimized, and learned by the system exist in 3D space, the initial inputs and the final generated outputs are often these 2D perspective images. Furthermore, a “second perspective” typically refers to a synthesized image from an arbitrary perspective or slice that was not included in the original input slices. This second perspective of the scene is generated using a model and includes its own generated exposure level, allowing the system to synthesize high-quality novel views from any arbitrary angle.

As used herein, the term “brightness function” refers to a mathematical mapping, computational model, or neural representation that is configured to learn and predict an optimal lighting parameter, such as an exposure or brightness value, for an individual three-dimensional point within a scene. Rather than defining brightness or exposure merely as a global camera setting or as a function of a camera's location and viewing direction, a brightness function treats these lighting characteristics as an inherent property of the three-dimensional position itself. In various implementations, this function acts as a mathematical mapping from a three-dimensional space to a one-dimensional exposure or brightness value. A specific, implemented example of a brightness function is a neural exposure field, which may be parameterized as a fully-connected multi-layer perceptron. Typically, a brightness function is evaluated and optimized jointly alongside a separate three-dimensional scene representation model, such as a neural radiance field or a model utilizing Gaussian splats, to condition the scene representation based on the predicted local lighting. By determining the optimal brightness directly in a three-dimensional space and utilizing weighting functions to selectively filter out unsuitable training pixels, the brightness function enables a system to generate high-quality, three-dimensionally consistent novel views from real-world captures that exhibit varying lighting conditions or high dynamic ranges.

As used herein, a “neural exposure field” refers to a three-dimensional (3D) neural field or machine learning model, such as a fully-connected multi-layer perceptron (MLP), that is configured to learn and predict improved exposure value for any individual 3D point within a scene. Rather than defining exposure as a function of a camera's location and viewing direction, a neural exposure field defines exposure as a function of 3D position, acting as a mathematical mapping from a 3D space to a one-dimensional (1D) exposure value. Typically, a neural exposure field is trained and optimized jointly alongside a separate 3D scene representation model, such as a neural radiance field (NeRF), to condition the scene representation and enable the generation of high-quality, 3D-consistent novel view synthesis results. Furthermore, the neural exposure field can be trained using a cost function or reconstruction loss that incorporates a weighting function, which weights the training signals by evaluating whether a pixel is well-exposed and well-saturated, thereby discarding overly bright or pitch-black pixels during optimization.

As used herein, the term “color function” generally refers to a computational model, mathematical mapping, or neural representation that operates as a three-dimensional scene representation. A color function typically evaluates a specific point in a three-dimensional space alongside a viewing direction and maps them to structural and visual properties, such as a volume density and a color value (e.g., an RGB color value). A specific, implemented example of a color function is a neural radiance field, which is often parameterized as a fully-connected multi-layer perceptron. Alternatively, a color function may parameterize and represent the geometry and visual properties of the scene utilizing other advanced data structures, such as three-dimensional Gaussian splats. In various implementations of the described view synthesis architectures, a color function operates as a second model that is jointly generated with, and explicitly conditioned upon, lighting information predicted by a first model, such as a brightness function or a neural exposure field. For instance, an optimal predicted exposure value can be transformed into a logarithmic domain and integrated directly into an intermediate feature representation, such as a bottleneck vector, of the color function. To determine a final color prediction for a pixel on a two-dimensional image plane, the color function evaluates local properties at multiple sample points along a ray and approximates the final pixel color utilizing volume rendering techniques like quadrature or alpha compositing. Ultimately, this deep exposure conditioning ensures the color function's predictions accurately reflect varying lighting states, enabling the robust generation of high-quality, three-dimensionally consistent novel perspectives.

As used herein, “neural radiance field” refers to a computational model, such as a neural network or multi-layer perceptron (MLP), that operates as a three-dimensional (3D) scene representation by mapping a point in 3D space and a viewing direction to a volume density and a color value, such as an RGB color value. To determine a final color prediction for a pixel, the neural radiance field evaluates these properties for sample points along a ray and approximates the final color via techniques such as quadrature or alpha compositing. In some implementations, the neural radiance field functions as a second model that is conditioned on exposure information predicted by a first model, such as a neural exposure field. For example, a predicted exposure value may be transformed into a logarithmic domain and applied to a bottleneck vector of the neural radiance field MLP, which allows the model to adjust for varying exposure levels across the scene and generate high-quality, 3D-consistent novel views.

As used herein, the term “predicted brightness” generally refers to an estimated, improved, or optimal lighting parameter or brightness value generated by a computational model, such as a brightness function or a neural exposure field, for a specific location or three-dimensional point within a scene. A predicted brightness may be computed along at least one ray passing through a three-dimensional point, where the brightness is equal to a product of a function of transmittance and a local brightness evaluated at sample points along that ray. During the training or optimization of the system, a difference between the predicted brightness and an observed (ground-truth) brightness at the three-dimensional point can be evaluated to calculate a reconstruction loss. This evaluation is frequently weighted utilizing metrics like well-exposedness and saturation to selectively discard unsuitable training signals, such as overly bright (pure white) or pitch-black pixels. Furthermore, the predicted brightness can be volume-rendered to a two-dimensional image plane and utilized to condition a scene representation model, such as a color function or a neural radiance field. This conditioning is often achieved by applying a logarithmic transformation to the predicted brightness and mathematically integrating it into an intermediate feature representation, such as a bottleneck vector, of the scene representation model. By directly providing these calculated, natively 3D-consistent lighting parameters to the rendering pipeline, the system can dynamically compensate for varying lighting conditions and generate high-quality, three-dimensionally consistent novel views.

As used herein, “predicted exposure” refers to an estimated or optimal exposure value generated by a computational model, such as a neural exposure field, for a specific location or three-dimensional point within a scene. A predicted exposure may be computed along at least one ray passing through a three-dimensional point, where the exposure is equal to a product of a function of transmittance and a local exposure at sample points along that ray. During the training or optimization of the system, a difference between the predicted exposure and an observed (ground truth) exposure at the three-dimensional point can be evaluated to calculate a reconstruction loss, which is often weighted to discard overly bright or pitch-black pixels. Furthermore, the predicted exposure can be volume-rendered to a two-dimensional image plane and utilized to condition a scene representation model, such as a neural radiance field. This conditioning is often achieved by applying a logarithmic transformation to the predicted exposure and feeding it into a bottleneck vector of the neural radiance field, thereby enabling the system to compensate for varying lighting conditions and generate high-quality, three-dimensionally consistent novel views.

As used herein, “transmittance” refers to a value or property associated with sample points along a ray passing through a three-dimensional scene, often evaluated in conjunction with absorptions, alpha values, and distances between neighboring samples. In the context of the described view synthesis models, transmittance is utilized during volume rendering or quadrature to approximate final predictions for a pixel. For instance, a neural radiance field uses transmittance values evaluated for sample points along a ray to approximate a final color prediction for a pixel. Additionally, transmittance may be utilized when determining exposure, where a predicted exposure computed along at least one ray through a three-dimensional point is equal to a product of a function of transmittance and a local exposure at a point along that ray.

As used herein, the term “observed brightness” generally refers to a ground-truth or input lighting parameter, such as an exposure value, associated with a real-world capture or perspective of a scene. During the training and optimization of the described view synthesis models, an observed brightness is utilized to supervise a computational model, such as a brightness function, by calculating a reconstruction loss. In this context, the brightness function operates as a more general version of a local exposure, which represents a specific lighting or brightness value at a sample point along a ray that passes through a three-dimensional point within the scene. Specifically, the system optimizes the models by evaluating a difference between a predicted brightness generated by the model and the observed brightness at a three-dimensional point. Because some areas of an initial image capture may be pure white or pitch black, the evaluation of this difference is often modified using a weighting function that relies on the corresponding color values, such as well-exposedness and saturation, to assign weights to the reconstructions and discard unsuitable pixels. Ultimately, the observed brightness represents the actual lighting settings, such as exposure times, derived from the input images, which the system leverages to properly train the brightness function to generate a high-quality, three-dimensionally consistent scene representation.

As used herein, a “local exposure” refers to an exposure value at a specific sample point along a ray that passes through a three-dimensional point within a scene. In the context of generating an optimal exposure utilizing a model, such as a neural exposure field, a predicted exposure evaluated along at least one ray is computed as being equal to a product of a function of transmittance and the local exposure at a point along that ray. This computation allows the system to volume-render the three-dimensional exposure predictions to a two-dimensional image plane during the training and optimization process.

As used herein, a “ray” refers to a path or projection extending through a three-dimensional scene, along which a plurality of three-dimensional sample points are evaluated by a computational model. In the context of a neural radiance field, a ray is utilized to approximate the final color prediction for a specific pixel on a two-dimensional image plane via quadrature or volume rendering. This approximation involves evaluating characteristics such as transmissions, absorptions, alpha values, and color values (e.g., RGB values) at various sample points along the ray. Additionally, when determining lighting characteristics within the scene, a predicted exposure can be computed along at least one ray passing through a three-dimensional point. This computed exposure along the ray is equal to a product of a function of transmittance and a local exposure evaluated at a point along that ray. During the optimization or training of these models, batches of rays are sampled to update the network weights and minimize reconstruction loss, thereby enabling the generation of high-quality, three-dimensionally consistent novel views.

As used herein, an “observed exposure” refers to a ground-truth or input exposure value associated with a real-world capture or perspective of a scene. During the training and optimization of the described view synthesis models, an observed exposure is utilized to supervise a neural exposure field by calculating a reconstruction loss. Specifically, the system evaluates a difference between a predicted exposure generated by the model and the observed exposure at a three-dimensional point. Because some areas of an initial capture may be pure white or pitch black, the evaluation of this difference is often modified using a weighting function that relies on the corresponding color values (such as well-exposedness and saturation) to assign weights to the reconstructions and discard unsuitable pixels. Ultimately, the observed exposure represents the actual exposure settings, such as exposure times, derived from the input images, which the system leverages to properly train the neural exposure field to generate a high-quality, three-dimensionally consistent scene representation.

As used herein, a “weight” refers to a value or function-such as a per-pixel weight or weighting function-utilized during the training of a computational model to evaluate whether a pixel is suitable for optimization. In the context of learning a neural exposure field, a weight is computed corresponding to a predicted color value at a three-dimensional point, and is used to discard unsuitable training signals, such as over-exposed (pure white) or under-exposed (pitch black) pixels. Computing this weight typically involves generating an exposure weight, which is calculated by computing an exponential of a square of the color value, as well as generating a saturation weight, which is calculated by computing a square of a difference between the color value and a mean color value. These components are then combined to determine the final per-pixel weight, often by evaluating a product of the exposure weight raised to a first power and the saturation weight raised to a second power, where these powers act as hyperparameters to control the influence of each respective metric.

As used herein, a “color value” refers to a quantitative representation of the color properties at a specific location, such as a Red, Green, Blue (RGB) value. In the context of the described neural scene representations, a neural radiance field maps a point in three-dimensional space and a viewing direction to a volume density and an RGB color value. To determine a final color prediction for a two-dimensional pixel, the system approximates the color by evaluating the color values (along with characteristics like transmittance and alpha values) at multiple sample points along a ray. During the training and optimization process, a predicted color value generated by the network may be compared against an observed, ground-truth RGB color value to calculate a reconstruction loss. Furthermore, the predicted color value at a three-dimensional point is utilized to compute a weight for training a neural exposure field by determining whether a pixel is suitable for optimization (e.g., discarding over-exposed white or under-exposed black pixels). Specifically, an exposure weight may be generated by computing an exponential of a square of the color value, and a saturation weight may be generated by computing a square of a difference between the color value and a mean color value.

As used herein, an “exposure weight” refers to a metric utilized during the training of a computational model, such as a neural exposure field, to determine how well-exposed a predicted color is at a given pixel or three-dimensional point. Specifically, an exposure weight is generated by computing an exponential of a square of a color value. This calculation evaluates whether a pixel's color is at or near clipping boundaries, which helps identify if the pixel is over-exposed (e.g., pure white) or under-exposed (e.g., pitch black). During the optimization process, the exposure weight is typically combined with a saturation weight to compute a final per-pixel weight for a weighting function, which dictates whether a pixel is a suitable training signal or should be discarded. In practice, combining these weights can involve evaluating a product of the exposure weight raised to a first power and the saturation weight raised to a second power, where these powers act as hyperparameters to control the influence of each respective metric.

As used herein, a “saturation weight” refers to a metric evaluated during the training of a computational model, such as a neural exposure field, to determine whether a pixel's color is well-saturated and therefore provides a suitable training signal. Specifically, a saturation weight is generated by computing a square of a difference between a color value and a mean color value. This mean color value typically represents the average of the red, green, and blue (RGB) components of that specific color. During the optimization process, the saturation weight is utilized in a weighting function and combined with an exposure weight to calculate a final per-pixel weight. This combined weighting mechanism ensures that the model learns from high-quality pixels while discarding unsuitable training signals, such as over-exposed (pure white) or under-exposed (pitch black) areas. In practice, combining these components often involves evaluating a product of the exposure weight raised to a first power and the saturation weight raised to a second power, where these powers act as hyperparameters to control the influence of the saturation metric in faithfully reconstructing well-fused colors.

As used herein, “mean color value” refers to the average of the red, green, and blue (RGB) components of a given predicted color. In the context of optimizing a neural exposure field, the mean color value is utilized to evaluate whether a pixel's color is well-saturated, ensuring the model learns from high-quality visual signals. Specifically, the system uses the mean color value to generate a saturation weight by computing a square of a difference between the predicted color value and the mean color value. This saturation weight is subsequently combined with an exposure weight to determine a final per-pixel weight, acting as a filtering mechanism to discard unsuitable training signals, such as overly bright (pure white) or pitch-black pixels.

As used herein, “normally-distributed noise vector” refers to a mathematical vector representing a small spatial offset or distance in three-dimensional (3D) space that is sampled from a normal (Gaussian) distribution (e.g., ε~ [symbol] (0,0.05). In the context of learning and optimizing a neural exposure field, this noise vector is utilized to add regularization in 3D space. Specifically, the system evaluates the difference between a predicted exposure at a first 3D point and a predicted exposure at another nearby 3D point, where the nearby point is separated by a distance based on the normally-distributed noise vector. Penalizing this calculated difference regularizes the neural exposure field based on the intuitive hypothesis that an ideal exposure changes smoothly in 3D space, since nearby 3D points are presumably well-exposed at similar exposure times. Utilizing this spatial regularization ultimately leads to improved model performance and the generation of high-quality, 3D-consistent view synthesis.

As used herein, “difference” refers to a calculated variance, discrepancy, or mathematical subtraction between two values, which is frequently evaluated during the training and optimization of computational models to compute losses, weights, or regularization metrics. In the context of the described neural representations, the system may evaluate a difference between a predicted exposure and an observed (ground-truth) exposure at a three-dimensional point to calculate a reconstruction loss for a neural exposure field. Similarly, the system may evaluate a difference between a predicted color and an observed color at a three-dimensional point to supervise a neural radiance field via a color reconstruction loss. Beyond direct loss calculations, a difference is utilized to compute weights for weighting functions; for instance, a saturation weight is generated by computing a square of a difference between a predicted color value and a mean color value to determine if a pixel is suitable for optimization. Additionally, a difference is used to apply spatial regularization to the model by evaluating a difference between the predicted exposure at a given three-dimensional point and the predicted exposure at another nearby three-dimensional point, which is typically separated by a distance based on a normally-distributed noise vector.

As used herein, “bottleneck vector” refers to an intermediate feature representation or structural component within a computational model, such as a multi-layer perceptron (MLP) representing a neural radiance field. In the context of the described view synthesis systems, the bottleneck vector acts as an integration point for applying latent exposure conditioning, functioning as the mechanism through which exposure information is fed into the neural network. Specifically, a predicted exposure value generated by a neural exposure field is typically transformed into a logarithmic space and then added to or combined with the bottleneck vector of the neural radiance field. This conditioning allows the model to adjust its final color predictions based on the varying exposure levels of the scene. Furthermore, the dimensionality of the bottleneck vector can be adjusted based on the complexity or type of the captured scene; for example, a default dimension of 256 may be utilized, while a reduced dimension (e.g., 15) may be implemented for forward-facing scenes to help prevent the model from overfitting.

As used herein, a “joint generation of models” refers to the simultaneous or end-to-end training and optimization of two or more computational models. In the context of the described view synthesis systems, this involves learning a first model, such as a neural exposure field, alongside a second model, such as a neural radiance field or 3D scene representation. Rather than optimizing the models independently, the neural scene representation and the exposure field are trained together from the input captures. Specifically, the cost function used to train the neural exposure field is trained together with the neural radiance field's cost function. This joint generation is facilitated by a latent exposure conditioning mechanism that directly feeds the exposure information predicted by the first model into the second model. In various implementations, both models may be trained jointly for a specified number of iterations, such as 10,000 iterations for forward-facing scenes or 25,000 iterations for room-level multi-view captures. Ultimately, jointly generating these models enables the system to robustly reconstruct scenes and produce high-quality, three-dimensionally consistent appearances from real-world captures with varying exposures.

As used herein, the term “Gaussian splats” generally refers to a technique or data structure utilized by a computational model to represent a three-dimensional scene. While the described view synthesis systems frequently utilize standard neural fields or neural radiance fields (such as multi-layer perceptrons) to model an environment, the system's architecture may be expanded such that at least one of the models-such as the first model generating an exposure or the second model generating a perspective-represents the scene using Gaussian splats. Furthermore, when generating a novel second perspective of the scene, the view may be generated utilizing high dynamic range (HDR) captures that are specifically represented by the Gaussian splats. Implementations leveraging Gaussian splatting (such as 3DGS or HDR-GS models) can be evaluated and optimized alongside exposure fields to render high-quality, three-dimensionally consistent novel views from input captures.

As used herein, the term “high dynamic range” (or HDR) generally refers to a visual scenario, capture, or representation that exhibits significant variations in lighting and exposure levels, such as an indoor room featuring large window fronts overlooking a bright outdoor area. In conventional graphics applications, accurately rendering high dynamic range scenes typically requires a professional capture setup, multi-exposure captures, or a separate 2D tone-mapping process utilizing professional software to recover target appearances. In the context of the described view synthesis techniques, the system overcomes these limitations by utilizing a computational model, such as a neural exposure field, to learn optimally-exposed colors directly in a 3D space, enabling accurate reconstructions in high dynamic range scenarios without relying on such manual post-processing steps. While the system can produce HDR-resembling results using only sampled RGB images, high dynamic range captures and datasets are frequently utilized to simulate varying exposures and apply exposure fusion to generate well-exposed target images for model evaluation. Additionally, in certain implementations, high dynamic range captures may be utilized as inputs to generate synthesized perspectives of a scene that are represented by Gaussian splats.

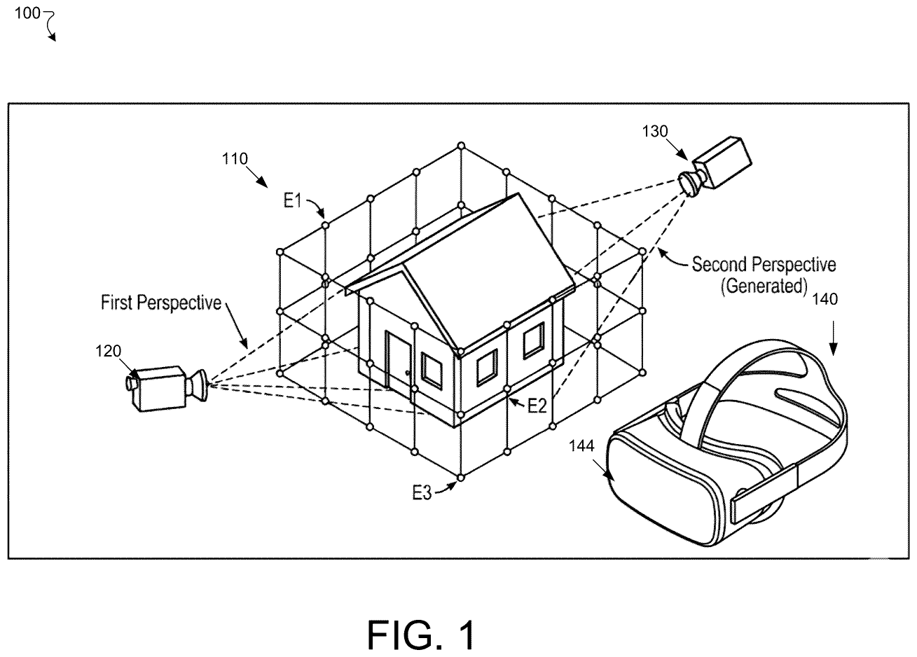

FIG. 1 is a diagram illustrating an example scenario 100 in novel view synthesis using a neural exposure field. FIG. 1 illustrates a diagram of an improved view synthesis process for robustly reconstructing three-dimensional (3D) scenes with high quality and a 3D-consistent appearance. FIG. 1 depicts a representative 3D environment or scene 110, which undergoes evaluation and processing by advanced machine learning systems to generate novel views. As depicted, the overall architecture involves capturing initial input images and transforming them via computational models into generated output perspectives.

In FIG. 1, scene 110 represents a 3D environment, shown conceptually containing a house structure. Scene 110 includes a plurality of three-dimensional points distributed throughout the 3D space in a grid-like fashion, which are continuously evaluated by the system's models. These specific locations in 3D space represent points with assigned exposure values, such as the points labeled E1, E2, and E3.

These points E1, E2, and E3 correspond to specific spatial locations where a neural exposure field operates. The system generates an exposure at these three-dimensional points of the scene using a first model. This first model can represent the neural exposure field, which functions as a mathematical mapping from the 3D space to a one-dimensional exposure value, predicting an optimal, well-exposed value for each individual 3D point like E1 through E3.

In FIG. 1, a camera 120 is positioned at a first perspective to capture an initial input view of scene 110. A processor 144 of a head-worn device 140 acquires this first perspective of the scene to use as foundational data for the reconstruction. The first perspective received by processor 124 represents a real-world capture, which often features strong exposure variations, varying lighting conditions, or specific camera exposure settings that can degrade traditional 3D rendering models.

In standard digital photography, capturing environments with a high dynamic range-such as bright sunlight mixing with deep indoor shadows-typically requires capturing multiple different exposures on a tripod and manually blending them using post-processing software. Relying on a single snapshot from a standard camera often results in clipped highlights (areas that are pure white and lack detail) or crushed shadows (areas that are pitch black). The technology illustrated in FIG. 1 overcomes these standard photographic limitations natively by optimizing exposure directly in a 3D space rather than relying on standard 2D image post-processing tricks.

During the view synthesis process, the input captures from camera 120 are utilized by processor 144 to train the computational models. Specifically, the system generates the exposure at the three-dimensional points (E1-E3) of scene 110 using the first model by computing a predicted exposure along at least one ray passing through the three-dimensional point. This predicted exposure is equal to a product of a function of transmittance and a local exposure evaluated at sample points along that ray.

The view synthesis process depicted by the large directional arrow in FIG. 1 relies on a second model, which represents a neural radiance field. The neural radiance field operates alongside the neural exposure field to map points in 3D space and viewing directions to volume densities and color values. This second model evaluates characteristics at various sample points to approximate final pixel color predictions.

To bridge the exposure information at points E1-E3 with the final scene reconstruction, the system employs a mechanism known as latent exposure conditioning. The neural radiance field depends on a bottleneck vector of the second model, the exposure, and the first perspective of the scene. In this conditioning mechanism, the predicted exposure from the first model is transformed into a logarithmic domain and added to the bottleneck vector of the neural radiance field to guide the color predictions.

The models corresponding to the scene representation and the exposure fields are generated jointly through end-to-end training. Rather than processing these models in isolation, the cost function used to train the neural exposure field is trained simultaneously with the cost function of the neural radiance field. During this joint optimization, the system evaluates a difference between the predicted exposure and an observed exposure at a point (e.g., E1), and computes a weight corresponding to a color value to ensure that overly bright or dark pixels are safely discarded during training.

In FIG. 1, a camera 130 is positioned at a generated second perspective. The system generates a second perspective of the scene 110 using the second model, based on the first perspective of the scene and the exposure at the three-dimensional point of the scene. Processor 144 generates a synthesized, novel view of scene 110 that was not part of the original input captures provided by camera 120.

Ultimately, the view synthesis process shown in FIG. 1 results in the generation of high-quality, high-dynamic-range resembling appearances from arbitrary viewpoints, such as the view generated for camera 130. By predicting optimal exposure values at discrete 3D points like E1, E2, and E3 throughout scene 110 based on the initial captures from camera 120, the processor 144 natively ensures strict 3D consistency across all generated perspectives. This comprehensive process reduces the need for manual post-processing steps or complex multi-exposure capture rigs when reconstructing robust 3D environments from real-world data.

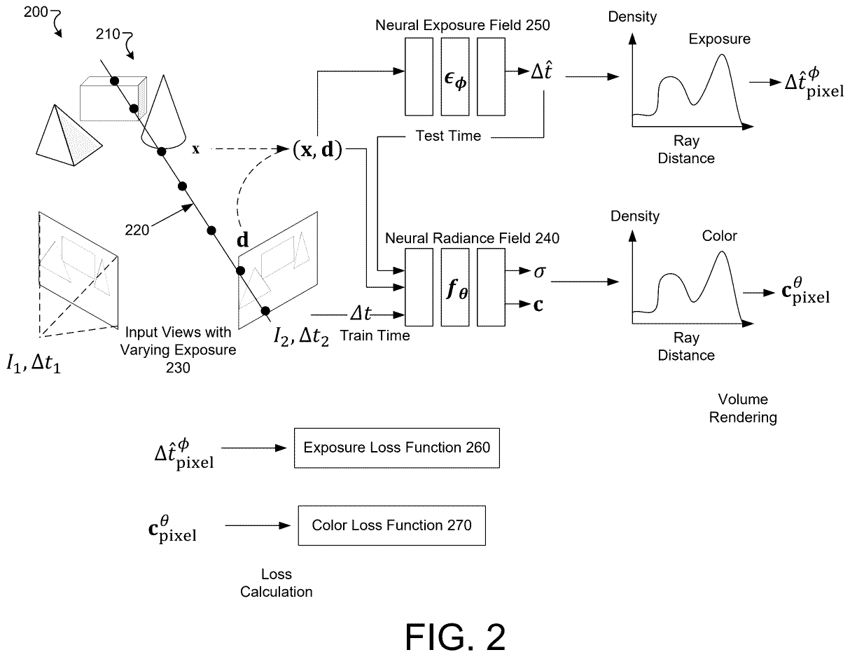

FIG. 2 is a diagram illustrating an example diagram illustrating an interaction 200 between a neural exposure field and a neural radiance field in developing their respective models.

FIG. 2 provides an overarching method overview of the improved view synthesis architecture, illustrating the process of simultaneously training two parallel computational models. The system takes as input a set of RGB images having corresponding exposure times and outputs a comprehensive neural representation. This generated representation is capable of producing a high-quality, high dynamic range (HDR)-resembling appearance in a strictly three-dimensionally consistent manner from arbitrary viewpoints. The environment being evaluated is depicted as scene 210, which serves as the foundational 3D space being reconstructed by the models.

Reconstructing a robust scene 210 from real-world photography involves overcoming significant limitations inherent to standard digital camera sensors. In typical real-world settings, such as capturing a room with bright outdoor light streaming through a window, cameras struggle to capture the full spectrum of light in a single shot, leading to overexposed white areas or underexposed black shadows. Traditional graphics pipelines often require a photographer to bracket multiple exposures on a tripod and manually blend them using professional tone-mapping software. The architecture in FIG. 2 eliminates the need for these manual 2D post-processing steps or complex professional setups.

The pipeline begins with an input view with varying exposure 200, which serves as the primary ground-truth data for the machine learning models. These input captures represent everyday images taken with differing exposure times or automatic camera settings that naturally fluctuate as a camera moves through a space. Because these standard RGB images lack perfect, uniform lighting, relying on them natively would typically cause severe artifacts or floating geometry in standard rendering systems.

To evaluate the scene 210, the system employs a ray-marching strategy where a plurality of sample points are evaluated sequentially. Specifically, points are sampled along a ray 220 that is cast from the camera's perspective through the 3D space. This technique borrows from fundamental computer graphics ray tracing principles, where the physics of light is simulated by projecting mathematical lines from a virtual camera's focal point, through a 2D image plane, and out into the modeled 3D environment.

The evaluation of these points along the ray 220 forms the basis of the entire volumetric rendering process. At each discrete sample point along the ray 220, the system queries the computational models to predict specific local properties, such as the density of the geometry and the color of the light at that exact location in the scene 210. By aggregating these point-wise predictions along the entire length of the ray 220, the system can approximate what a human eye or camera lens would observe for a single corresponding pixel on a 2D image.

The first primary machine learning model utilized in this evaluation is the neural radiance field 230. A neural radiance field operates as a fully connected multi-layer perceptron (MLP) that models the complex geometrical and visual properties of the environment. Rather than storing the environment as a mesh of triangles or a grid of voxels, the neural radiance field 230 memorizes the scene's continuous volume mathematically within the weights of its neural network.

During the training phase, for each point along the ray 220, the neural radiance field 230 receives the 3D coordinate and the viewing direction as inputs. Using these inputs, the model predicts both a volume density and an RGB color value. The volume density dictates how solid or transparent the space is at that point, while the color value determines the visual appearance of the surface or medium.

Operating in parallel with the scene representation is the neural exposure field 240. The neural exposure field 240 is a second computational model, also parameterized as a multi-layer perceptron, that acts as a 3D neural field dedicated exclusively to predicting an optimal exposure value for any given point in the scene 210. By predicting exposure directly in a 3D space rather than relying on 2D image plane adjustments, the model guarantees a consistent exposure across varying camera angles.

A hypothesis concerning the neural exposure field 240 is that there exists an ideal, optimally-exposed value for every individual 3D point in the environment. Instead of defining exposure as a global camera setting or a function of the camera's location, the system treats exposure as an inherent property of the 3D position itself. This allows the system to recognize that a point near a bright window should inherently have a different optimal exposure setting than a point nestled in a dark corner of the room.

As depicted in the graphs of FIG. 2, the properties evaluated along the ray 220 fluctuate as a function of ray distance. The system tracks how density, color, and exposure vary continuously as the ray penetrates deeper into the scene 210. These varying signals are critical because they represent the distribution of physical matter, the reflected light, and the optimal camera sensor timing distributed throughout the 3D volume, respectively.

To transform these 3D properties into a 2D image, the architecture utilizes a volume rendering process. Volume rendering involves techniques such as alpha compositing and quadrature, which mathematically integrate the density and color predictions along the ray 220 to compute a single final pixel value. This process simulates how light attenuates and accumulates as it passes through semi-transparent and solid objects in the real world before hitting a camera lens.

The final color prediction for the neural radiance field 230 is obtained by volume-rendering the predicted color and density values to the 2D image plane. This synthesized 2D image can then be directly compared against the actual real-world photograph captured by the camera to measure how well the network is performing its reconstruction tasks.

Similarly, the 3D predictions from the neural exposure field 240 are also volume-rendered to the image plane. The exposure predictions generated along the ray 220 are aggregated using the same alpha blending weights calculated during the RGB rendering pass. This novel approach allows the network to project a 3D map of optimal exposure values down into a 2D exposure mask, creating a one-to-one mapping between the predicted scene colors and their corresponding ideal lighting levels.

FIG. 2 delineates the pipeline into two distinct phases: Train Time and Test Time. During Train Time, the models are aggressively optimized using backpropagation to minimize mathematical errors between their predictions and the ground-truth data. During Test Time, the trained weights of the networks are frozen, and the system is queried to generate completely novel perspectives of the scene 210 that were never explicitly captured by a camera.

To generate the neural radiance field 230, the system employs a color loss function 270. This function calculates a Mean Squared Error (MSE) or similar reconstruction loss by evaluating the difference between the final predicted color of a pixel and the observed ground-truth color from the input view with varying exposure 200. By continuously reducing the color loss function 270, the network slowly learns to reproduce the geometry and textures of the environment.

The system trains the neural exposure field 240 using an exposure loss function 260. The exposure loss function 260 evaluates the difference between the predicted exposure rendered to the image plane and the actual input exposure. In some implementations, the system jointly optimizes both the color loss function 270 and the exposure loss function 260 end-to-end, allowing the two networks to share information and improve cooperatively.

The exposure loss function includes a weighting function. Because standard real-world images contain severe overexposure and underexposure, penalizing the network for failing to recreate a pure white or pitch-black pixel would destroy the model's accuracy. Thus, the system weights the training signals by evaluating the saturation and well-exposedness of the color; if a pixel is too close to clipping boundaries, it is dynamically discarded during the training of the neural exposure field 240.

To link the two parallel models, the architecture employs a latent exposure conditioning mechanism. During Train Time, the neural radiance field 230 is explicitly conditioned on the input exposure of the ground-truth images to accurately reconstruct the observed scene. The exposure data is mathematically transformed into a logarithmic space and added directly into the internal bottleneck vector of the radiance field, ensuring the color predictions are heavily informed by the camera's lighting state.

However, an advantage of this system is realized during Test Time. Instead of feeding the neural radiance field 230 a manual camera setting, the system may condition the radiance rendering directly on the predictions output by the fully trained neural exposure field 240. The neural exposure field acts as an automated, intelligent director, passing precisely calculated, perfectly exposed lighting data into the rendering pipeline for every single spatial coordinate.

To summarize, by evaluating a scene 210 along a ray 220 and jointly optimizing a neural radiance field 230 alongside a neural exposure field 240, the system handles challenging high dynamic range scenarios. The resulting synthesized views are vibrant, perfectly lit, and structurally immaculate, bridging the gap between casual real-world photography and professional-grade 3D environment generation.

A radiance field f maps a point in 3D space x ∈ [symbol] ³ together with a viewing direction d ∈ [symbol] ² to a volume density σ ∈ [symbol] ⁺ and an RGB color value c ∈ [symbol] ³. The final color prediction for a pixel is approximated via quadrature using sample points along the ray:

$${c}_{pixel} = {\sum }_{j = 1}^{{N}_{s}} {τ}_{j} {α}_{j} {c}_{j} , \qquad ( 1 )$$

$${τ}_{j} = {\prod }_{k = 1}^{j - 1} ( 1 - {α}_{k} ) , {α}_{j} = 1 - {e}^{- {σ}_{j} {δ}_{j}} , {δ}_{j} = {‖ {x}_{j + 1} = {x}_{j} ‖}_{2}$$

where τⱼ is transmittance, αⱼ is the alpha value for xⱼ, and δⱼ is the distance between neighboring samples.

A neural radiance field can improve an MLP f_{θ} parameterized by network weights θ, using gradient descent with a reconstruction loss:

$${ℒ}_{f} ( θ ) = {\sum }_{r ∈ {ℛ}_{batch}} {‖ {c}_{pixel}^{θ} ( r ) - {c}_{pixel}^{*} ( r ) ‖}_{2}^{2} \qquad ( 2 )$$

where r ∈ [symbol] _{batch} are sampled batches of rays. Multi-sampling and a multi-resolution backbone such as Zip-NeRF can produce satisfactory performance in view synthesis and such an architecture may be used here. In some implementations, some complex real-world scenes, affine GLO embedding vectors are added to increase robustness. In some implementations, for forward-facing scenes, such as those as present in the HDRNeRF dataset, modifications for view-dependent color predictions are used to prevent overfitting. More specifically, for such forward-facing scenes, the view-dependent branch may be adjusted from three layers with 256 hidden units to two layers with 64 hidden units. In some implementations, the bottleneck dimensionality is reduced to 15 and the skip connection to the second layer is removed.

Many real-world captures contain significant exposure variations and provide a per-image ground-truth exposure value. This can enable use of per-image exposure as an input to the model alongside the RGB images and condition the color prediction on exposure. To this end, the classical nonparametric Conditional Random Fields (CRF) calibration is used and the conditioning in the logarithm radiance domain is performed. Nevertheless, the transformation is applied to the bottleneck vector of the MLP as follows:

$${f}_{θ} ( x , d , Δ t ( r ) ) = {f}_{θ}^{view} ( {f}_{θ}^{pos} ( x ) + ln Δ t ( r ) , d ) , \qquad ( 3 )$$

where x is the sample point, d the viewing direction, Δt(r) the exposure of corresponding ray r, and

$${f}_{θ}^{p o s} ( x )$$

the bottleneck vector. In some implementations,

$${f}_{θ}^{p o s} ( x )$$

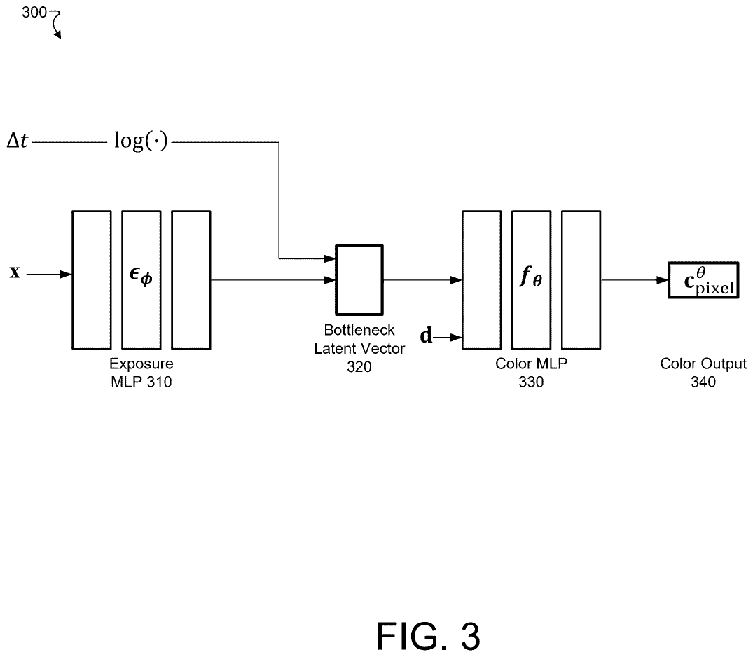

predicts log radiance so that no transformation is used (see, e.g., FIG. 3). Such a latent conditioning may provide improved performance. During training, the NeRF f_{θ} may be conditioned on the input exposure to reconstruct the input images following Eq. (2). At test time, however, f_{θ} may be conditioned on the neural exposure field prediction.

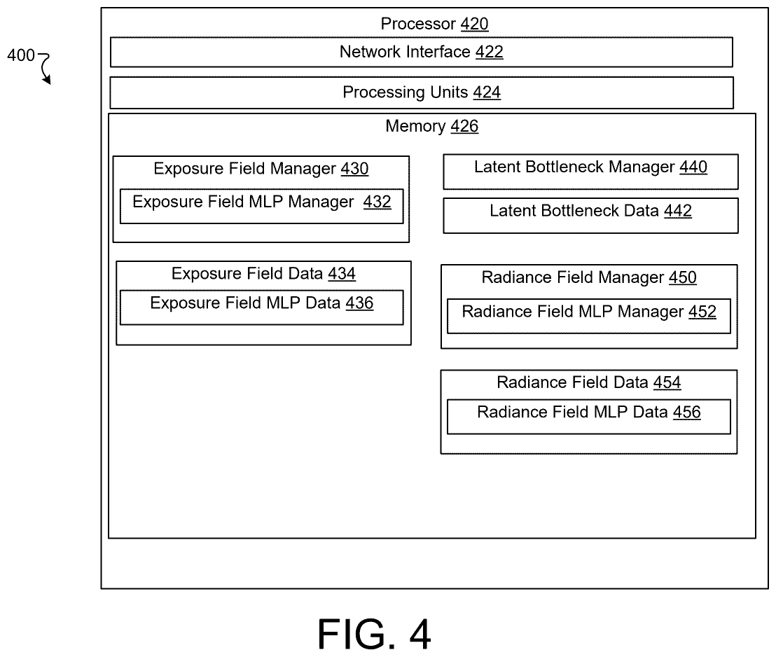

A per-scene neural exposure field may be improved to predict an improved exposure for each 3D point:

$${e}_{ϕ} : {ℝ}^{3} \to ℝ , x ↦ Δ \hat{t} ( x ) \qquad ( 4 )$$

where φ indicates the network parameters and Δ\hat{t}(x) the predicted exposure at 3D point x. In contrast to a conventional formulation of exposure, exposure may be defined not as a function of the camera location and viewing direction, but rather as a function of 3D position. Such a definition is based on a hypothesis that there exists an improved exposure value for each 3D point for which the predicted color is well-exposed (see, e.g., FIG. 4). This definition enables learning high-quality appearances for high-dynamic range scenarios that are consistent in 3D, in contrast to other methods that perform tone-mapping on the 2D image plane leading to inconsistent synthesis across views.

The neural exposure field e is parametrized as a fully-connected MLP. This neural exposure field may be improved alongside the scene representation f_{θ}. The goal is not necessarily to reproduce the input exposure per view, as that exposure may not be ideal for each 3D point, but rather to learn an improved exposure for each 3D point. As a result, an objective may be defined that is suited for unsupervised learning settings.

Objective 1: Well-Exposedness. A pixel's color is often referred to as over- or under-exposed if the color value is close or at the clipping boundaries. More specifically, well-exposed may be defined as follows:

$${w}_{exp} ( c ) = {\prod }_{i} exp ( - \frac{{( {c}_{i} - 1 / 2 )}^{2}}{{σ}_{exp}} ) , \qquad ( 5 )$$

where σₑₓₚ is a hyperparameter controlling the sharpness of the weight curve.

Objective 2: Saturation. While a goal involves learning ideal exposure per 3D point, inspiration may be drawn from classical image processing to integrate an objective that aims to obtain well saturated colors. More specifically, a saturation may be defined as follows:

$${w}_{sat} ( c ) = \sqrt{\frac{1}{3} {\sum }_{i} {( {c}_{i} - {μ}_{c} )}^{2}} , \qquad ( 6 )$$

where μ_{c} defines the mean of the R, G, and B values of c.

Given that there is no target ground truth 3D exposure available and that this may be formulated as an unsupervised optimization problem, it may be deduced that adding regularization in 3D space may lead to better results. Intuitively, it may be hypothesized that an ideal exposure changes smoothly in 3D space as nearby 3D points are presumably well-exposed at similar exposure times. More specifically, the squared distance may be calculated between predicted exposure of nearby 3D points as follows:

$$Δ {t}_{diff} = {‖ {e}_{ϕ} ( x ) - {e}_{ϕ} ( x + ϵ ) ‖}_{2}^{2} , \qquad ( 7 )$$

where ϵ~ [symbol] (0, 0.05) is a small 3D normally-distributed noise vector. Δt_{diff} may be penalized to regularize the neural exposure field that in turn leads to improved performance.

A target RGB or HDR appearance is not assumed but rather improved exposure may be learned to produce high-quality, 3D consistent appearance in an unsupervised manner. The exposure of input views may be selectively backpropagated if the color is well exposed and well saturated, according to the objective functions. This way, there need not be an assumption that every pixel is well exposed in certain views, which is often not the case. Rather an assumption may be made that most areas in the 3D scene show well exposed colors in some view. More specifically, it may be observed that predicted exposure may be rendered similarly to color as follows:

$$Δ {t}_{pixel} = {\sum }_{j = 1}^{{N}_{s}} {τ}_{j} {α}_{j} Δ {\hat{t}}_{j} , \qquad ( 8 )$$

where τ, α, and δ are the same as in (1). Next, a per-pixel weight may be defined as follows:

$$w ( c ) = {{w}_{exp} ( c )}^{{λ}_{exp}} {{w}_{sat} ( c )}^{{λ}_{sat}} , \qquad ( 9 )$$

where λₑₓₚ and λₛₐₜ are hyperparameters controlling the influence of the respective mask.

Next, the exposure difference of nearby sample points may be similarly rendered as follows:

$$Δ {t}_{reg} = {\sum }_{j = 1}^{{N}_{s}} {τ}_{j} {α}_{j} Δ {t}_{diff}^{j} , \qquad ( 10 )$$

The neural exposure field e_{φ} may be trained with the input exposure as follows:

$${ℒ}_{e} ( ϕ ) = {\sum }_{r ∈ {ℛ}_{batch}} {‖ Δ {\hat{t}}_{pixel}^{ϕ} ( r ) - Δ t ( r ) ‖}_{2}^{2} + Δ {t}_{reg}^{ϕ} ( r )$$

Joint Improvement. The neural scene representation f_{θ} and exposure field e_{φ} may be trained end-to-end from the input captures. The full loss formulation may take the following form:

$$ℒ ( θ , ϕ ) = {ℒ}_{f} ( θ ) + {ℒ}_{e} ( ϕ ) . \qquad ( 11 )$$

RGB images may be used with exposure as input and no additional labels are required. Using the color-based criteria, high-quality, HDR-resembling 3D consistent view synthesis results may be produced that can be shown on ordinary displays, while other configurations require e.g., a target HDR image from an artist or access to professional HDR software.

FIG. 3 is a diagram illustrating an example flow of information 300 through a bottleneck latent vector. FIG. 3 illustrates a detailed schematic of the latent exposure conditioning mechanism, which acts as the critical bridge between the scene's geometrical representation and its lighting representation. The figure highlights how exposure information is fed into the neural network to accurately reconstruct three-dimensional scenes from real-world captures featuring high dynamic ranges. By comparing conventional rendering pathways with the improved architecture, the diagram demonstrates how deeply integrating exposure data leads to more stable optimization and substantially higher-quality novel view synthesis.

Conventional models may attempt to condition the color prediction on the log exposure by adding it directly onto the radiance at the very end of the pipeline. As illustrated in the conceptual comparison, this late-stage addition means the network's internal features are computed without any awareness of the lighting conditions. Adjusting the final radiance linearly or logarithmically after the complex geometrical and texture features have already been processed frequently leads to degraded results, particularly when the scene contains drastic exposure variations like bright windows or dark shadows.

To overcome the instability and limitations of late-stage conditioning, the improved architecture employs a novel latent exposure conditioning mechanism. The process begins with the fundamental inputs required for ray-marching in a 3D environment: a specific three-dimensional spatial coordinate (often denoted as x) and a viewing direction (often denoted as d). Alongside these spatial and directional inputs, an exposure value (Δt) is also provided, representing either the metadata from an input capture during training or a predicted optimal exposure during test time.

Within this architecture, an exposure MLP 310 (Multi-Layer Perceptron) is utilized to model the exposure characteristics of the environment. Acting as a dedicated neural exposure field, the exposure MLP 310 functions as a mathematical mapping from the 3D space to a one-dimensional exposure value. Instead of relying on traditional 2D tone-mapping, this network continuously predicts a natively 3D-consistent exposure value for any given spatial point, allowing the system to recognize exactly how much light should be expected at that specific location.

The primary neural radiance field may then process the 3D spatial coordinate to generate an intermediate structural representation, designated as the bottleneck latent vector 320. In neural network architectures, a bottleneck vector serves as a compressed, highly informative latent space that captures the essential geometric and material properties of the scene before view-dependent effects are applied. The dimensionality of the bottleneck latent vector 320 can be dynamically adjusted depending on the complexity of the scene; for example, a default dimension of 256 may be used, while a reduced dimension of 15 may be implemented for forward-facing scenes to prevent the model from overfitting.

At this junction, the exposure information is injected into the network's latent space. Instead of adding the exposure at the end of the rendering process, the predicted exposure value is transformed into a logarithmic domain and mathematically added directly on top of the bottleneck latent vector 320. This crucial step ensures that the deep, internal representations of the neural radiance field are explicitly conditioned on the lighting state, allowing the network to adapt its subsequent calculations based on whether the point is in a brilliantly lit area or a deep shadow.

Once the exposure data is fused into the bottleneck latent vector 320, the conditioned latent features are combined with the viewing direction (d) and fed into the color MLP 330. The color MLP 330 represents the view-dependent branch of the neural radiance field, responsible for computing how light reflects and textures appear from specific camera angles. Because this branch receives the exposure-conditioned latent vector, it can accurately model complex, high-dynamic-range appearances and view-dependent scatter without overcompensating for localized lighting errors.

The color MLP 330 ultimately generates a color output 340, which represents the final predicted RGB color for that specific sample point along the ray. Because this color output 340 was derived from a conditioned latent space rather than a superficial post-processing adjustment, the resulting colors are more faithful to the real-world ground truth. These point-based color predictions may be subsequently volume-rendered-aggregated along the entire ray—to approximate the final color for a 2D pixel on the image plane.

During the joint generation and optimization of these models, the quality of the Color Output 340 is continuously evaluated via a reconstruction loss. The system compares the predicted pixel color (C_{θ,pixel}) generated by the network against the ground-truth RGB color (C_{*,pixel}) captured by the camera. By passing the exposure information through the bottleneck latent vector 320 and strictly evaluating the color output 340 utilizing selective weighting functions to discard unsuitable pixels, the entire architecture successfully reconstructs vibrant, optimally exposed, and strictly 3D-consistent environments.

FIG. 4 is a diagram illustrating an example electronic environment 400 in which in which novel view synthesis using a neural exposure field is used. As shown in FIG. 4, the electronic environment includes a processor 420.

The processor 420 includes a network interface 422, one or more processing units 424, and the (nontransitory) memory 426. In some implementations, the processor 420 is the processor 144 in FIG. 1. The network interface 142 includes, for example, Ethernet adaptors, Bluetooth adaptors, and the like, for converting electronic and/or optical signals received from the network to electronic form for use by the processor 420. The set of processing units 424 include one or more processing chips and/or assemblies. The memory 426 is a storage medium and includes both volatile memory (e.g., RAM) and non-volatile memory, such as one or more read only memories (ROMs), disk drives, solid state drives, and the like. The set of processing units 424 and the memory 426 together form part of the processor 420, which is configured to perform various methods and functions as described herein as a computer program product.

In some implementations, one or more of the components of the processor 420 can be, or can include processors (e.g., processing units 424) configured to process instructions stored in the memory 426. Examples of such instructions as depicted in FIG. 4 include an exposure field manager 430, a latent bottleneck manager 440, and a radiance field manager 450. Further, as illustrated in FIG. 4, the memory 426 is configured to store various data, which is described with respect to the respective managers that use such data.

The exposure field manager 430 is configured to predict an optimal exposure value for each three-dimensional point in a scene, treating exposure as a function of 3D position rather than a global camera setting. The exposure field manager 430 utilizes exposure field data 434, which stores the input exposure metadata (Δt) derived from the original image captures. The exposure field data 434 also stores calculated evaluation metrics, such as exposure weights and saturation weights, which are used to determine if a pixel is well-exposed and well-saturated during optimization. The exposure field manager 430 includes an exposure field MLP manager 432.

The exposure field MLP manager 432 is configured to oversee the fully-connected Multi-Layer Perceptron (MLP) architecture of the neural exposure field, executing operations through four hidden layers with a hidden dimension of, e.g., 128 and ReLU activations. The network parameters and weights (denoted as φ) optimized by the exposure field MLP manager 432 are continuously updated and securely stored within the exposure field MLP data 436.

The radiance field manager 450 is configured to oversee the primary neural 3D scene representation. The radiance field manager 450 is configured to manage the ray-marching operations, integrating volume densities and RGB colors at various sample points along a ray to approximate final pixel colors via quadrature. The underlying data for these operations is held in the radiance field data 454. The radiance field data 454 stores the foundational elements required for scene reconstruction, including the ground-truth RGB input images, the calculated transmittance values, and the final color predictions output by the models. The radiance field manager 450 includes the radiance field MLP manager 452.

The radiance field MLP manager 452 is configured to control the execution of the scene's geometry and color networks and is configured to manage the multi-layer perceptron (denoted as f_{θ}), mapping spatial coordinates and viewing directions to volume densities and view-dependent colors. For complex scenes, the radiance field MLP manager 452 may utilize three layers with 256 hidden units, while for forward-facing scenes it may scale down to two layers with 64 hidden units to prevent overfitting. The parameters and network weights (denoted as θ) defining the continuous volume of the 3D scene are stored within the radiance field MLP data 456.

The latent bottleneck manager 440 is configured to provide a bridge between the exposure model and the radiance model. The latent bottleneck manager 440 is configured to execute the latent exposure conditioning mechanism by transforming the predicted exposure into a logarithmic domain and adding it to the internal features of the radiance field. The latent bottleneck data 442 stores these intermediate, compressed feature representations known as bottleneck vectors. The dimensionality of the data stored here can vary depending on the environment; the system may utilize a default dimension of 256, but the latent bottleneck manager 440 may reduce this dimension to 15 for specific forward-facing captures.

The components (e.g., modules, processing units 424) of processor 420 can be configured to operate based on one or more platforms (e.g., one or more similar or different platforms) that can include one or more types of hardware, software, firmware, operating systems, runtime libraries, and/or so forth. In some implementations, the components of the processor 420 can be configured to operate within a cluster of devices (e.g., a server farm). In such an implementation, the functionality and processing of the components of the processor 420 can be distributed to several devices of the cluster of devices.

The components of the processor 420 can be, or can include, any type of hardware and/or software configured to process attributes. In some implementations, one or more portions of the components shown in the components of the processor 420 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processor 420 can be, or can include, a software module configured for execution by at least one processor (not shown). In some implementations, the functionality of the components can be included in different modules and/or different components than those shown in FIG. 4, including combining functionality illustrated as two components into a single component.

Although not shown, in some implementations, the components of the processor 420 (or portions thereof) can be configured to operate within, for example, a data center (e.g., a cloud computing environment), a computer system, one or more server/host devices, and/or so forth. In some implementations, the components of the processor 420 (or portions thereof) can be configured to operate within a network. Thus, the components of the processor 140 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, exposure field manager 430 (and/or a portion thereof), latent bottleneck manager 440 (and/or a portion thereof), and radiance field manager 450 (and/or a portion thereof) are examples of such instructions.

In some implementations, the memory 426 can be any type of memory such as a random-access memory, a disk drive memory, flash memory, and/or so forth. In some implementations, the memory 426 can be implemented as more than one memory component (e.g., more than one RAM component or disk drive memory) associated with the components of the processor 420. In some implementations, the memory 426 can be a database memory. In some implementations, the memory 426 can be, or can include, a non-local memory. For example, the memory 426 can be, or can include, a memory shared by multiple devices (not shown). In some implementations, the memory 426 can be associated with a server device (not shown) within a network and configured to serve the components of the processor 420. As illustrated in FIG. 4, the memory 426 is configured to store various data, including exposure field data 434 and latent bottleneck data 442.

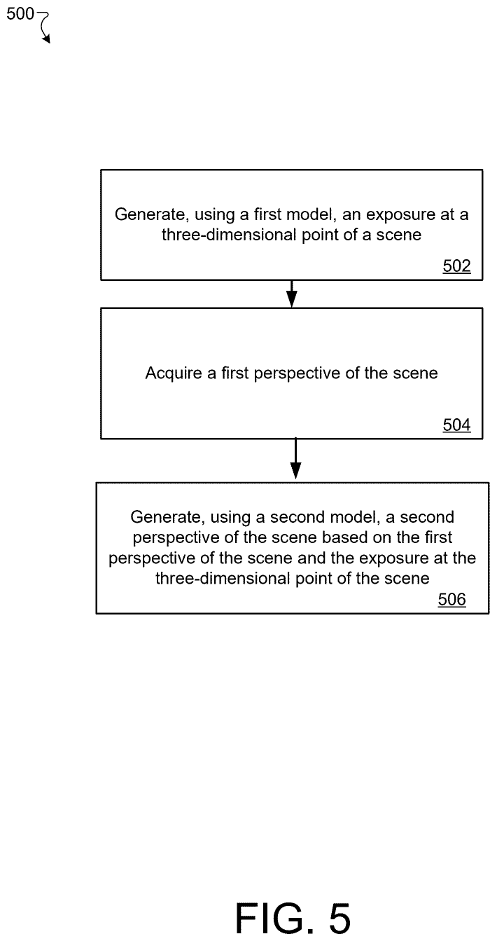

FIG. 5 is a flow chart illustrating an example method 500 of performing novel view synthesis using a neural exposure field. The method 500 may be performed in a processor, e.g., processing unit 424 (FIG. 4).

At 502, the processor generates, using a first model (e.g., neural exposure field 250) a brightness at a three-dimensional location of a scene (e.g., scene 210).

At 504, the processor receives a first perspective of the scene (e.g., first perspective 120).

At 506, the processor generates, using a second model (e.g., neural radiance field 240), a second perspective (e.g., second perspective 130) of the scene based on the first perspective of the scene and the brightness at the three-dimensional location of the scene.

Example 1. A method, comprising: receiving, using a first model, a brightness at a three-dimensional location of a scene; receiving a first perspective of the scene; and generating, using a second model, a second perspective of the scene based on the first perspective of the scene and the brightness at the three-dimensional location of the scene.

Example 2. The method as in example 1, wherein the first model represents a brightness function and the second model represents a color function.

Example 3. The method as in example 2, wherein generating the brightness at the three-dimensional location of the scene using the first model includes: computing a predicted brightness along at least one ray through the three-dimensional location, the predicted brightness being based on a function of transmittance and a brightness at a point along the at least one ray.

Example 4. The method as in example 3, wherein generating the brightness at the three-dimensional location of the scene using the first model further includes: evaluating a difference between the predicted brightness and an observed brightness at the three-dimensional location; and computing a weight corresponding to a color value at the three-dimensional location.

Example 5. The method as in example 4, wherein computing the weight corresponding to the color value at the three-dimensional location includes: generating a first weight by computing an exponential of the color value; generating a second weight by computing a difference between the color value and a mean color value; and combining the first weight and the second weight.

Example 6. The method as in example 5, wherein combining the first weight and the second weight includes: evaluating a product of the first weight raised to a first power and the second weight raised to a second power.

Example 7. The method as in example 3, wherein generating the brightness at the three-dimensional location of the scene using the first model further includes: evaluating a difference between the brightness function at the three-dimensional location and the brightness function at another three-dimensional locatiopn, the another three-dimensional location being a distance from the three-dimensional location, the distance being smaller than a threshold.

Example 8. The method as in example 2, wherein the color function depends on a color predicted by the second model, the brightness, and the first perspective of the scene.

Example 9. The method as in example 8, wherein generating the second perspective of the scene includes: predicting a predicted color at the three-dimensional location using the color function, wherein the color function is based on a logarithm of the brightness; and evaluating a difference between the predicted color and an observed color at the three-dimensional location.

Example 10. The method as in example 1, wherein the first model and the second model are generated jointly.

Example 11. The method as in example 1, wherein at least one of the first model and the second model represents the scene using Gaussian splats.

Example 12. The method as in example 1, further comprising evaluating a first metric indicating a first difference between a first color predicted by the color function and the observed color of the scene; and comparing the first metric with a second metric indicating a second difference between a second color predicted by another color function and the observed color of the scene, the another color function being independent of the brightness at the three-dimensional location of the scene.

Example 13. A computer program product comprising a nontransitory storage medium, the computer program product including code that, when executed by processing circuitry, causes the processing circuitry to perform a method, the method comprising: receiving, using a first model, a brightness at a three-dimensional location of a scene; receiving a first perspective of the scene; and generating, using a second model, a second perspective of the scene based on the first perspective of the scene and the brightness at the three-dimensional location of the scene.

Example 14. The computer program product as in example 13, wherein the first model represents a brightness function and the second model represents a color function.

Example 15. The computer program product as in example 14, wherein generating the brightness at the three-dimensional location of the scene using the first model includes: computing a predicted brightness along at least one ray through the three-dimensional location, the predicted brightness being based on a function of transmittance and a brightness at a point along the at least one ray.

Example 16. The computer program product as in example 15, wherein generating the brightness at the three-dimensional location of the scene using the first model further includes: evaluating a difference between the predicted brightness and an observed brightness at the three-dimensional location; and computing a weight corresponding to a color value at the three-dimensional location.

Example 17. The computer program product as in example 16, wherein computing the weight corresponding to the color value at the three-dimensional location includes: generating a first weight by computing an exponential of the color value; generating a second weight by computing a difference between the color value and a mean color value; and combining the first weight and the second weight.

Example 18. The computer program product as in example 15, wherein generating the brightness at the three-dimensional location of the scene using the first model further includes: evaluating a difference between the brightness function at the three-dimensional location and the brightness function at another three-dimensional location, the another three-dimensional location being a distance from the three-dimensional location, the distance being smaller than a threshold.

Example 19. The computer program product as in example 14, wherein the color function depends on a color predicted by the second model, the brightness, and the first perspective of the scene.

Example 20. The computer program product as in example 19, wherein generating the second perspective of the scene includes: predicting a predicted color at the three-dimensional location using the color function, wherein the color function is based on a logarithm of the brightness; and evaluating a difference between the predicted color and an observed color at the three-dimensional location.

Example 21. An electronic apparatus, comprising: a processor coupled to a memory, the processor being configured to: receive, using a first model, a brightness at a three-dimensional location of a scene; receive a first perspective of the scene; and generate, using a second model, a second perspective of the scene based on the first perspective of the scene and the brightness at the three-dimensional location of the scene.

Example 22. The electronic apparatus as in example 21, wherein the first model represents a brightness function and the second model represents a color function.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining or displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method, comprising:
receiving, using a first model, a brightness at a three-dimensional location of a scene;
receiving a first perspective of the scene; and
generating, using a second model, a second perspective of the scene based on the first perspective of the scene and the brightness at the three-dimensional location of the scene.

2. The method of claim 1, wherein the first model represents a brightness function and the second model represents a color function.

3. The method of claim 2, wherein generating the brightness at the three-dimensional location of the scene using the first model includes:
computing a predicted brightness along at least one ray through the three-dimensional location, the predicted brightness being based on a function of transmittance and a brightness at a point along the at least one ray.

4. The method of claim 3, wherein generating the brightness at the three-dimensional location of the scene using the first model further includes:
evaluating a difference between the predicted brightness and an observed brightness at the three-dimensional location; and
computing a weight corresponding to a color value at the three-dimensional location.

5. The method of claim 4, wherein computing the weight corresponding to the color value at the three-dimensional location includes:
generating a first weight by computing an exponential of the color value;
generating a second weight by computing a difference between the color value and a mean color value; and
combining the first weight and the second weight.

6. The method of claim 5, wherein combining the first weight and the second weight includes:
evaluating a product of the first weight raised to a first power and the second weight raised to a second power.

7. The method of claim 3, wherein generating the brightness at the three-dimensional location of the scene using the first model further includes:
evaluating a difference between the brightness function at the three-dimensional location and the brightness function at another three-dimensional location, the another three-dimensional location being a distance from the three-dimensional location, the distance being smaller than a threshold.

8. The method of claim 2, wherein the color function depends on a color predicted by the second model, the brightness, and the first perspective of the scene.

9. The method of claim 8, wherein generating the second perspective of the scene includes:
predicting a predicted color at the three-dimensional location using the color function, wherein the color function is based on a logarithm of the brightness; and
evaluating a difference between the predicted color and an observed color at the three-dimensional location.

10. The method of claim 1, wherein the first model and the second model are generated jointly.

11. The method of claim 1, wherein at least one of the first model and the second model represents the scene using Gaussian splats.

12. The method of claim 2, wherein the color function is a first color function, the method further comprising:
evaluating a first metric indicating a first difference between a first color predicted by the first color function and the observed color of the scene; and
comparing the first metric with a second metric indicating a second difference between a second color predicted by a second color function and the observed color of the scene, the second color function being independent of the brightness at the three-dimensional location of the scene.

13. A computer program product comprising a nontransitory storage medium, the computer program product including code that, when executed by processing circuitry, causes the processing circuitry to perform a method, the method comprising:
receiving, using a first model, a brightness at a three-dimensional location of a scene;
receiving a first perspective of the scene; and
generating, using a second model, a second perspective of the scene based on the first perspective of the scene and the brightness at the three-dimensional location of the scene.

14. The computer program product of claim 13, wherein the first model represents a brightness function and the second model represents a color function.

15. The computer program product of claim 14, wherein generating the brightness at the three-dimensional location of the scene using the first model includes:
computing a predicted brightness along at least one ray through the three-dimensional location, the predicted brightness being based on a function of transmittance and a brightness at a point along the at least one ray.

16. The computer program product of claim 15, wherein generating the brightness at the three-dimensional location of the scene using the first model further includes:
evaluating a difference between the predicted brightness and an observed brightness at the three-dimensional location; and
computing a weight corresponding to a color value at the three-dimensional location.

17. The computer program product of claim 16, wherein computing the weight corresponding to the color value at the three-dimensional location includes:
generating a first weight by computing an exponential of the color value;
generating a second weight by computing a difference between the color value and a mean color value; and
combining the first weight and the second weight.

18. The computer program product of claim 15, wherein generating the brightness at the three-dimensional location of the scene using the first model further includes:
evaluating a difference between the brightness function at the three-dimensional location and the brightness function at another three-dimensional location, the another three-dimensional location being a distance from the three-dimensional location, the distance being smaller than a threshold.

19. The computer program product of claim 14, wherein the color function depends on a color predicted by the second model, the brightness, and the first perspective of the scene.

20. The computer program product of claim 19, wherein generating the second perspective of the scene includes:
predicting a predicted color at the three-dimensional location using the color function, wherein the color function is based on a logarithm of the brightness; and
evaluating a difference between the predicted color and an observed color at the three-dimensional location.

21. An electronic apparatus, comprising:
a processor coupled to a memory, the processor being configured to:
receive, using a first model, a brightness at a three-dimensional location of a scene;
receive a first perspective of the scene; and
generate, using a second model, a second perspective of the scene based on the first perspective of the scene and the brightness at the three-dimensional location of the scene.

22. The electronic apparatus of claim 21, wherein the first model represents a brightness function and the second model represents a color function.
